(19) United States
(12) Patent Application Publication
(10) Pub. No.: US 2015/0205911 A1
(43) Pub. Date: Jul. 23, 2015

(54) System and Method for Predicting the Immunogenicity of a Peptide

(71) Applicant: Bayer Healthcare LLC, Whippany, NJ (US)

(72) Inventors: Fred Jullien Aswad, Oakland, CA (US); Pedro Paz, Hercules, CA (US)

(21) Appl. No.: 14/398,965

(22) PCT Filed: Mar. 14, 2013
(86) PCT No.: PCT/US2013/031661

§ 371 Date: Nov. 4, 2014

Related U.S. Application Data
(60) Provisional application No. 61/652,076, filed on May 25, 2012.

(51) Int. Cl. G06F 19/12

(52) U.S. Cl. CPC G06F 19/12

(57) ABSTRACT

A system, computer readable storage medium and method of predicting the immunogenicity of a peptide are provided. In certain cases the system includes: a) a model of a peptide, a model of a MHCII protein and a model of a T cell receptor; and b) an executable program for: (i) evaluating the strength of intermolecular interactions of a complex containing the peptide, the MHCII protein and the T cell receptor to provide a score that predicts the immunogenicity of the peptide; and (ii) outputting the score.

### CROSS-REFERENCING

This application is claims the benefit of U.S. provisional application Ser. No. 61/652,076, filed on May 25, 2012, which application is incorporated by reference in its entirety.

### INTRODUCTION

Human therapeutic proteins (biologics) isolated from natural sources or synthesized through recombinant methods can induce immune responses when administered to human patients. These immune responses can lead to effects ranging from minor skin irritation to decreased efficacy of the therapeutic drug, and in some instances can cause organ failure or death. Mitigating the potential for immunogenicity is one of the primary challenges of protein engineering. Therefore, tools and assays that allow the immunogenicity of a protein to be assessed pre-clinically can be important.

### BRIEF DESCRIPTION OF THE FIGURES

The skilled artisan will understand that the drawings, described below, are for illustration purposes only. The drawings are not intended to limit the scope of the present teachings in any way.

FIG. 1 illustrates one exemplary embodiment of a computer system that can be used for implementing the method illustrated in FIG. 2.

FIG. 2 illustrates some of the features of an exemplary embodiment of a method for predicting the immunogenicity of a peptide.

FIG. 3 illustrates one way in which the method illustrated in FIG. 2 can be implemented.

### SUMMARY

A computer system is provided. In certain embodiments, the computer system comprises a memory comprising: a) a model of a peptide, a model of a MHCII protein and a model of a T cell receptor; and b) an executable program for: (i) evaluating the strength of intermolecular interactions of a complex comprising the peptide, the MHCII protein and the T cell receptor to provide a score that predicts the immunogenicity of the peptide; and (ii) outputting the score. The memory can further comprise instructions for displaying an image of the complex on a display on the computer system.

A computer readable storage medium comprising an immunogenicity prediction program is also provided. In these embodiments, the medium can comprise instructions for: a) evaluating the strength of intermolecular interactions of a complex comprising a peptide, a MHCII protein and a T cell receptor to provide a score that predicts the immunogenicity of the peptide; and b) outputting the score, as summarized above. In certain embodiments, the immunogenicity prediction program comprises instructions for: a) evaluating the strength of intermolecular interactions of a plurality of complexes each comprising a peptide, a MHCII protein and a T cell receptor, where the complexes comprise different peptides and the instructions produce a score for each of the complexes; b) ranking the different peptides by their scores; and c) outputting a list of the different peptides ranked by their scores, thereby providing an immunological profile for the peptides.

A method of predicting the immunogenicity of a peptide is also provided. In certain embodiments, the method comprises: a) inputting sequence information of the peptide into a system comprising an immunogenicity prediction program comprising instructions for: (i) evaluating the strength of intermolecular interactions of a complex comprising the peptide, a MHCII protein and a T cell receptor, to provide a score that predicts the immunogenicity of the peptide; and (ii) outputting the score; b) executing the immunogenicity prediction program; and c) receiving the score from the system. In certain embodiments, the method can further comprise: d) ranking the scores.

These and other features of the present teachings are set forth herein.

### DEFINITIONS

Before describing exemplary embodiments in greater detail, the following definitions are set forth to illustrate and define the meaning and scope of the terms used in the description.

By “immunogenicity” and grammatical equivalents herein is meant the degree of an immune response, including but not limited to production of neutralizing and non-neutralizing antibodies, formation of immune complexes, complement activation, mast cell activation, inflammation, and anaphylaxis. Immunogenicity is species-specific. In some embodiments, immunogenicity refers to immunogenicity in humans. In some embodiments, immunogenicity refers to immunogenicity in rodents (including but not limited to rats, mice, hamster, guinea pigs, etc.), primates, farm animals (including but not limited to sheep, goats, pigs, cows, horses, etc.), and domestic animals, (including but not limited to cats, dogs, rabbits, etc).

By “immune response” and “immunological response” and grammatical equivalents herein is meant a response of the immune system to a molecule, including humoral or cellular immune responses. Non-limiting immunological responses include production of neutralizing and non-neutralizing antibodies, formation of immune complexes, complement activation, mast cell activation, inflammation, and anaphylaxis.

By “predictive” herein is meant the ability of a system or assay to act as a surrogate for in vivo immunogenicity and recapitulate or mimic the immunogenic outcome or response of therapeutic administration in a vertebrate in the absence of actual administration. That is, a system or assay is predictive of vertebrate immunogenicity if the system can demonstrate with reasonable accuracy that the protein antigen would have or would not have elicited an immunogenic response had it been administered.

By “increased immunogenicity” and grammatical equivalents herein is meant an increased ability to activate the immune system, when compared to a control, e.g., an unmodified protein. For example, a modified protein can be said to have “increased immunogenicity” if it elicits neutralizing or non-neutralizing antibodies in higher titer or in more subjects than an unmodified protein. In a particular embodiment, the probability of raising neutralizing antibodies is increased by at least 5%, e.g., at least 2-fold or at least 5-fold. For example, if an unmodified protein produces an immune response in 10% of subjects, a variant with enhanced immunogenicity would produce an immune response in more than 10% of subjects, e.g., more than 20% or more than 50% of subjects. A modified protein also can be said to have “increased immunogenicity” if it shows increased binding to one or more MHCI or MHCII alleles or if it induces T cell activation in an increased fraction of subjects relative to the parent protein. In some embodiments, the probability of T cell activation is increased by at least 5%, e.g., at least 2-fold or at least 5-fold.

By “reduced immunogenicity” and grammatical equivalents herein is meant a decreased ability to activate the immune system, when compared to a control, e.g., an unmodified protein. For example, if the therapeutic agent is protein, a modified protein can be said to have “reduced immunogenicity” if it elicits neutralizing or non-neutralizing antibodies in lower titer or in fewer subjects than an unmodified protein. In some embodiments, the probability of raising neutralizing antibodies is decreased by, for example, at least 5%, e.g., at least 50% or at least 90%. For example, if a parent protein produces an immune response in 10% of subjects, a modified protein with reduced immunogenicity would produce an immune response in less than 10% of subjects, e.g., less than 5% or less than 1% of subjects. A modified protein also can be said to have “reduced immunogenicity” if it shows decreased binding to one or more MHCI or MHCII alleles or if it induces T cell activation in a decreased fraction of subjects relative to an unmodified protein. In some embodiments, the probability of T cell activation is decreased by at least 5%, e.g., by at least 50% or at least 90%.

By “immunostimulatory” and grammatical equivalents herein is meant a part of a protein that stimulates an immune response that is greater than that generated in other, e.g., immunologically inert, parts of a protein.

By “immunologically inert” and grammatical equivalents herein is meant a part of a protein that that does not stimulate an immune response.

The terms “MHCI” and “MHC class I” include any human class I MHC molecules including all naturally occurring sequence variants of HLA-A, HLA-B and HLA-C, as well as equivalent molecules from other species.

The terms “MHCII” and “MHC class II” include any human class II MHC molecules, including all naturally occurring sequence variants of a DRA, DRB1, DRB3/4/5, DQA1, DQB1, and DPB1 molecules, as well as equivalent molecules from other species.

As used herein, the terms “TCR” and “T cell receptor” are used to refer to any human T cell receptor, and also those from other species.

As used herein, the term “inputting” is used to refer to any way of entering information into a computer. For example, in certain cases, inputting can involve selecting a sequence or a model that is already present on a computer system. In other cases, inputting can involve adding a sequence or a model to a computer system. Inputting can be done using a user interface.

As used herein, the term “executing” is used to refer to an action that a user takes to initiate a program.

As used herein, the term “docking” refers to a computational process of assembling two or more separate proteins into a complex.

As used herein, the term “evaluating the strength of intermolecular interactions” refers to any method for measuring how well two or more proteins bind to one another, including methods that measure affinity, complementarity, energetic favorability (which can be measured as a difference in free energy), etc.

As used herein, the term “sequence information”, in the context of inputting sequence information, is intended to include inputting an identifier for a sequence, inputting a sequence, and inputting structure information for a sequence (e.g., the atomic coordinates of a sequence).

As used herein, the term “receiving” is used to refer the delivery of information from the memory of a computer system to a user, usually in human readable form, e.g., in the form of a figure or a text file. This term is intended to encompass delivery of an image to the screen of a computer monitor, as well as delivery of a file to a user by electronic means, e.g., by e-mail or the like.

In any embodiment, data can be forwarded to a “remote location”, where “remote location,” means a location other than the location at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

As used herein, the term “model” refers to any way of representing data of the three dimensional structure of a protein. In some cases, a model can be presented as a set of atomic coordinates or an electron density map, for example. As would be understood, when the structure of a protein is referred to in the following description, it is the representation of the protein (i.e., the model of the protein, not the protein molecule itself) that is being referred to. Likewise, when the interactions of a complex are referred to, it is the interactions that are predicted to occur in a model of the complex that are being referred to. A model of a protein can include structural information (e.g., atomic coordinates) for post-translational modifications (e.g., phosphorylation or glycosylation, etc.). In some embodiments, a “model” may be produced by subjecting a protein to X-ray crystallography. In other embodiments, a model may be produced by homology modeling, i.e., modeling the amino acid sequence of a protein using the model of a highly related protein.

As used herein, the terms “MHCII protein” and “T cell receptor” refer to at least the parts of those proteins that bind to a peptide. As such, in certain embodiments, the method described below can be done using a model of the peptide binding groove of a MHCII protein, a model of the CDR3 region of a T cell receptor protein, and a model of the peptide. Models of other parts of these proteins (e.g., the CDR1 and CDR2 regions of the T cell receptor, or the T cell binding surface of the MHCII protein) can be employed in certain cases.

### DESCRIPTION OF VARIOUS EMBODIMENTS

This disclosure provides a system, computer readable storage medium and method for predicting the immunogenicity of a peptide. Using this system, computer readable storage medium or method, the immunogenicity of a protein can be assessed early in the research and development process, where a large number of candidates is available for screening. In certain cases, use of the subject method can reduce or eliminate the need to measure the immunogenicity of a candidate bioactive protein experimentally, e.g., using in vitro or in vivo assays, during drug development. Such experimental methods can be resource intensive and relatively slow.

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

The section headings used herein are for organizational purposes only and are not to be construed as limiting the subject matter described in any way. While the present teachings are described in conjunction with various embodiments, it is not intended that the present teachings be limited to such embodiments. On the contrary, the present teachings encompass various alternatives, modifications, and equivalents, as will be appreciated by those of skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the present disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, the some exemplary methods and materials are now described.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed.

It must be noted that as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order which is logically possible.

### Computer Systems

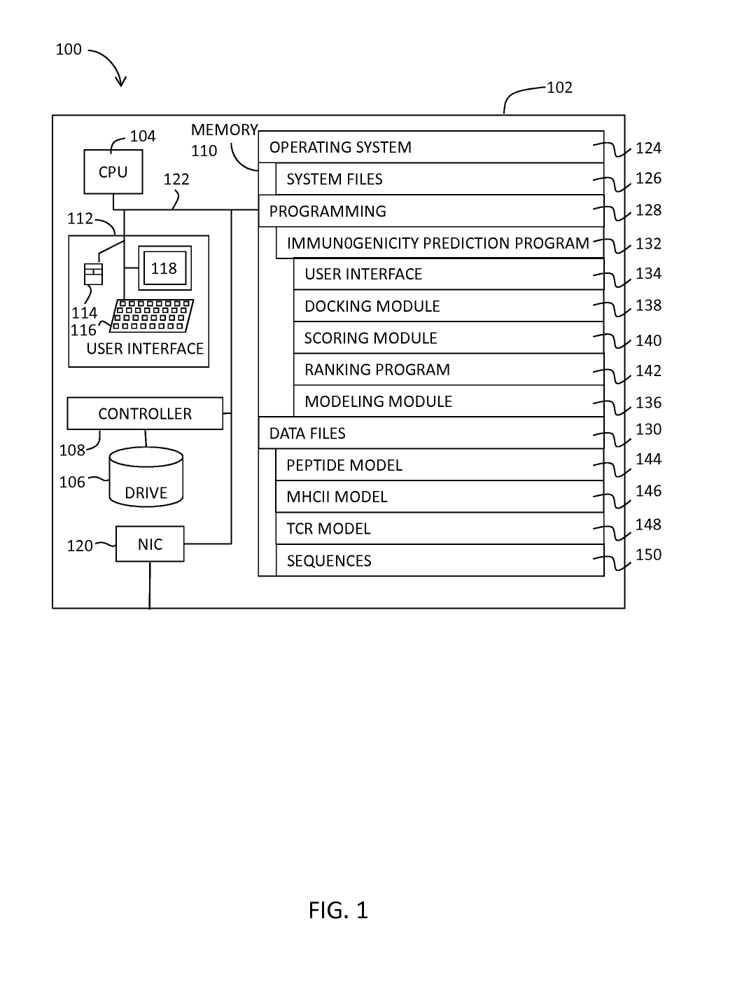

FIG. 1 illustrates an embodiment of a system 100 that can be employed to predict the immunogenicity of a peptide in accordance with the methods described below. As would be recognized by one of skilled in the art, many different hardware options and data structures can be employed to implement the method described below. The system illustrated in FIG. 1 is therefore, exemplary and is not limiting.

Substantially any general-purpose computer can be configured to a functional arrangement for the methods and programs disclosed herein. The hardware architecture of such a computer is well known by a person skilled in the art, and can comprise hardware components including one or more processors (CPU), a random-access memory (RAM), a read-only memory (ROM), an internal or external data storage medium (e.g., hard disk drive). A computer system can also comprise one or more graphic boards for processing and outputting graphical information to display means. The above components can be suitably interconnected via a bus inside the computer. The computer can further comprise suitable interfaces for communicating with general-purpose external components such as a monitor, keyboard, mouse, network, etc. In some embodiments, the computer can be capable of parallel processing or can be part of a network configured for parallel or distributive computing to increase the processing power for the present methods and programs. In some embodiments, the program code read out from the storage medium can be written into a memory provided in an expanded board inserted in the computer, or an expanded unit connected to the computer, and a CPU or the like provided in the expanded board or expanded unit can actually perform a part or all of the operations according to the instructions of the program code, so as to accomplish the functions described below. In other embodiments, the method can be performed using a cloud computing system. In these embodiments, the datafiles and the programming can be exported to a cloud computer, which runs the program, and returns an output to the user.

System 100 can in certain embodiments comprise a computer 102 that includes: a) a central processing unit 104; b) a main non-volatile storage drive 106, which can include one or more hard drives, for storing software and data, where the storage drive 106 is controlled by disk controller 108; c) a system memory 110, e.g., high speed random-access memory (RAM), for storing system control programs, data, and application programs, including programs and data loaded from non-volatile storage drive 106; d) system memory 110 can also include read-only memory (ROM); a user interface 112, including one or more input or output devices, such as a mouse 114, a keypad 116, and a display 118; e) an optional network interface card 120 for connecting to any wired or wireless communication network, e.g., a printer; and f) an internal bus 122 for interconnecting the aforementioned elements of the system.

The memory of a computer system can be any device that can store information for retrieval by a processor, and can include magnetic or optical devices, or solid state memory devices (such as volatile or non-volatile RAM). A memory or memory unit can have more than one physical memory device of the same or different types (for example, a memory can have multiple memory devices such as multiple drives, cards, or multiple solid state memory devices or some combination of the same). With respect to computer readable media, “permanent memory” refers to memory that is permanent. Permanent memory is not erased by termination of the electrical supply to a computer or processor. Computer hard-drive ROM (i.e., ROM not used as virtual memory), CD-ROM, floppy disk and DVD are all examples of permanent memory. Random Access Memory (RAM) is an example of non-permanent (i.e., volatile) memory. A file in permanent memory can be editable and re-writable.

Operation of computer 102 is controlled primarily by operating system 124, which is executed by central processing unit 104. Operating system 124 can be stored in system memory 110. In some embodiments, operating system 124 includes a file system 126. In addition to operating system 124, one possible implementation of system memory 110 includes a variety programming files 128 and data files 130 for implementing the immunogenicity prediction method described below. In certain cases, the programming 128 can contain an immunogenicity prediction program 132, where the immunogenicity prediction program 132 can be composed of various modules, e.g., a docking module 138, a scoring module 140, and a user interface module 134 that permits a user at user interface 112 to manually select or change the inputs to or the parameters used by programming 128. The memory can optionally contain a modeling module 136 for modeling a peptide, MHCII protein and/or TCR protein, and/or ranking module 142. Data files 130 can include various inputs for the programming, including peptide model 144, MHCII model 146 and TCR model 148 data files. Programming 128 can further include further programs which are not shown in FIG. 1. For example, programming 128 can contain a structure prediction module, e.g., a de novo modeling program or a best-fit modeling program, i.e., a program that predicts the structure of a TCR and/or MHCII amino acid sequence based on a known structure (obtained by, e.g., crystallography studies) to provide a new date file 130, e.g., a new peptide structure, a new MHCII structure and/or a new TCR structure. =In some embodiments, the MODELER program (Discovery Studio, Accelrys, San Diego, Calif.) can be used as the programming 128. Programming 128 can also contain a moving window module that moves a sliding window of defined size along the amino acid sequence of a long protein to provide different peptide sequences that can be modeled and input into immunogenicity prediction program 132 if a structure for such a peptide is not available.

The number of each of data files 144, 146 and 148 can vary greatly. In particular cases, there can be one of each file. However, in some cases, there can be from, e.g., 5 to 100 MHCII protein and/or TCR protein model files, although greater number of files (e.g., up to 1,000 or more) can be present in many cases. In certain cases, there can be from 1 to 100 or more peptide model files 144. In certain cases, the peptide model files 144 can contain structures for peptide sequences that are produced by processing an amino acid sequence for a candidate bioactive protein using a moving window module, and then processing the resultant amino acid sequences using a structure prediction module, as described herein. A sequence file 150 that contains the amino acid sequences for the peptide, MHCII protein and/or TCR protein can also be included.

Model files 144, 146 and 148 can be of any type suitable for representing the three dimensional structure of a protein. In certain embodiments, these files can be text files containing atomic coordinates of the various proteins, although any way of representing the three dimensional structure of a protein can be employed. In certain embodiments, the structure data files can contain a minimal amount of information for practicing the method. For example, a TCR structure data file can contain structural information for only the CDR3 of a TCR protein, because that region is primarily responsible for antigen binding. Likewise, a MHCII structure data file can contain structural information for only the binding groove of a MHCII protein.

In use, a user can input sequence information of a peptide into the system, and receive a ranked list of complexes from the system. In this method, the inputting can comprises selecting or typing an identifier that allows the computer to identity an input peptide structure. In certain cases, the user can input sequence information for a peptide, and the computer can model the peptide prior to initiating the method. In particular cases, in addition to sequence information about the peptide, the user can also input sequence information or models for the MHCII and/or TCR proteins.

### Computer-Readable Media

In certain embodiments, instructions in accordance with the method described herein can be coded onto a computer-readable medium in the form of “programming”, where the term “computer readable medium” as used herein refers to any storage or transmission medium that participates in providing instructions and/or data to a computer for execution and/or processing. Examples of storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer.

The computer-implemented method described herein can be executed using programming that can be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

### Methods

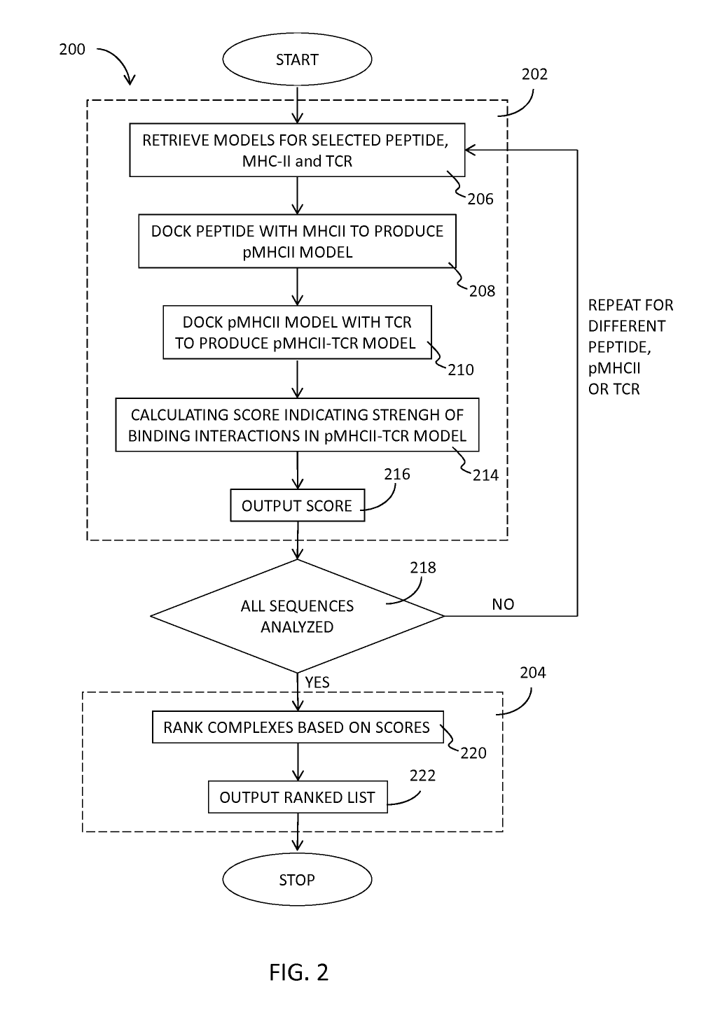

FIG. 2 illustrates one exemplary embodiment of a computer-implemented method 200 for predicting the immunogenicity of a peptide. In general terms, computer implemented method 200 is started by a user by inputting sequence information for one or more peptides into a computer system, and executing a program that predicts the immunogenicity of the peptide. The user then receives a score that predicts the immunogenicity of the peptide from the system. In the implementation shown in FIG. 2, the computer-implemented part of method 200 comprises a scoring sub-routine 202 for calculating the strength of the intermolecular interactions of a complex comprising a peptide, a MHCII protein and a T cell receptor to provide and output a score that predicts the immunogenicity of the peptide. Scoring sub-routine 202 can in certain cases be implemented in conjunction with a ranking sub-routine 204, which ranks the scores output by the scoring sub-routine 202 when scoring sub-routine 202 has been performed on several different complexes (thereby producing several scores) that can be ranked.

Scoring sub-routine 202 can be implemented using various programming modules (e.g., a docking module, a scoring module and an optional modeling module). In some embodiments, execution of the program by a user causes the computer to identify data files containing a model for the selected peptide, a model for the selected MHCII protein and a model for the selected TCR protein 206. The selected models are then docked (using, e.g., a docking module) to provide a peptide-MHCII (pMHCII) model 208. In some embodiments, the ZDOCK and RDOCK programs (Discovery Studio, Accelrys, San Diego, Calif.) are examples of programs that can be employed to provide the model. In certain cases, the model of the peptide can be rotated around its longitudinal axis in the binding groove of the MHCII protein to identify the complex that has most complementarity between the peptide and the MHCII protein, methods for which are known. Once a complex with optimal complementarity is identified, the degree of complementarity between the peptide and the binding groove in the pMHCII model can be calculated to quantify the most energetically favorable arrangement of the MHCII protein and the peptide. The degree of complementarity can be indicated by calculating the ΔG, i.e., the difference in free energy between two states, of the complex. In certain embodiments the free energy (G) of a protein or peptide is calculated using various approaches that take into account steric interactions, hydrophopic interactions, Van der Waals forces, etc. As those parameters are modified, the free of the energy of the protein changes. The difference in free energy of a protein model compared with a model of a denatured protein defines ΔG. In other words, G(folded protein)−G(denatured protein)=ΔG.

This figure, once obtained, can be used to eliminate pMHCII models from future steps in the method. For example, if the peptide does not dock with a MHCII protein with an affinity that is above a pre-defined threshold, the peptide is deemed non-immunogenic and can be eliminated in future steps of the method. In certain cases, a score indicating the degree of complementarity between the peptide and the MHCII protein can be calculated, and this figure can be used in conjunction with other measures, to calculate the immunogenicity score described below.

In the embodiment shown in FIG. 2, after a model of the pMHCII complex has been produced in step 208, the pMHCII complex can be docked with a TCR protein to produce a pMHCII-TCR model 210. After a model of the pMHCII-TCR complex is produced, a score that indicates how energetically favorable the pMHCII-TCR model is calculated 214. This can be expressed as a difference in free energies. The score can indicate the strength of the association between the TCR protein (particularly the CDR3 region of a TCR protein) and the peptide in the pMHCII complex. In certain cases, this calculation can also take into consideration the strength of the association between the peptide and the MHCII protein. The score is then output 216. The output can be any type of numerical evaluation, e.g., a number in the range of 1 to 100 or 1 to 1000 or more, although other types of scores, e.g., alphabetical scores, can be used in certain circumstances.

In certain embodiments, the method can be repeated on several different models that differ in, e.g., the amino acid sequence of the peptide, the amino acid sequence of the MHCII protein and/or the amino acid sequence of the TCR. As such, in certain embodiments, the programming can determine whether all selected sequences have been analyzed 218. If all models have not been analyzed, then the program is run with new inputs. If all models have been analyzed, then the program can rank the complexes based on their scores 220, and output a ranked list of the complexes 222. This ranking can be done by a ranking sub-routine 204.

Once output, the ranked list of scores can be retrievably recorded on a computer readable medium. A variety of data file types and formats can be used for storage. In some embodiments, a text file containing the names of the sequences in each of the complexes, and their respective immunogenicity scores, ranked by their immunogenicity scores, can be recorded.

The docking module of the programming can fit protein structures together using any suitable method. In one embodiment, the docking step can fit the proteins together based on the complementarity between two protein surfaces (see, e.g., Goldman et al, Proteins 2000 38: 79-94; Meng et al, Journal of Computational Chemistry 2004 13: 505-524 and Morris et al, Journal of Computational Chemistry 1998 19 (14): 1639-1662; all incorporated by reference). However, in some embodiments, the proteins can be fit together by calculating interaction energies for protein-protein pairs in conformational space (see, e.g., Feig et al, Journal of Computational Chemistry 2004 25: 265-84; incorporated by reference). The second of these methods can incorporate rigid body transformations (e.g., translations and rotations), as well as internal changes (e.g., torsion angle rotations). Other methods for docking are known.

The score that estimates the strength of the binding interactions in a pMHCII-TCR complex (specifically the strength of binding of the peptide in the complex to the TCR protein) can be calculated using any suitable method. In certain cases, the score can be calculated using any combination of force field, empirical or knowledge-based approaches. The force field approach is one in which affinities are estimated by summing the strength of intermolecular van der Waals and electrostatic interactions between atoms of the two proteins in the complex. The intramolecular energies (which can be referred to as “strain energy” in certain publications) of the two binding partners can be taken into consideration in certain cases. Finally since the binding can take place in an aqueous environment, the desolvation energies of the peptide and of proteins can sometimes be taken into account using implicit solvation methods such as Generalized Born model (which can be used to calculate the hydrophobic solvent accessible surface area) and/or the Poisson-Boltzmann equation (which describes the electrostatic environment of a solute in a solvent containing ions). In some embodiments, the scoring can be done by empirical methods, which are based on counting the number of various types of interactions between the two binding partners (see, e.g., Bohm J. Comput. Aided Mol. Des. 1998 12: 309-23; incorporated by reference). This scoring method is based on the number of atoms in contact with each other or by calculating the change in solvent accessible surface area (ΔSASA) in the complex compared to the uncomplexed proteins. The coefficients of the scoring function can be fit using multiple linear regression methods. The scoring can be done based the number of and strength of, e.g., hydrophobic-hydrophobic contacts (favorable), hydrophobic-hydrophilic contacts (unfavorable), hydrogen bonds (favorable, especially if shielded from solvent, if solvent exposed no contribution), and rotatable bonds immobilized in complex formation (unfavorable). Knowledge-based methods (also known as statistical potentials) are based on statistical observations of intermolecular close contacts in large 3D databases (such as the Cambridge Structural Database or Protein Data Bank) which are used to derive potentials of mean force. Knowledge-based methods are founded on the assumption that close intermolecular interactions between certain types of atoms or functional groups that occur more frequently than one would expect by a random distribution are likely to be energetically favorable and, therefore, contribute favorably to binding affinity (Muegge et al, J. Med. Chem. 2006 49: 5895-902; incorporated by reference).

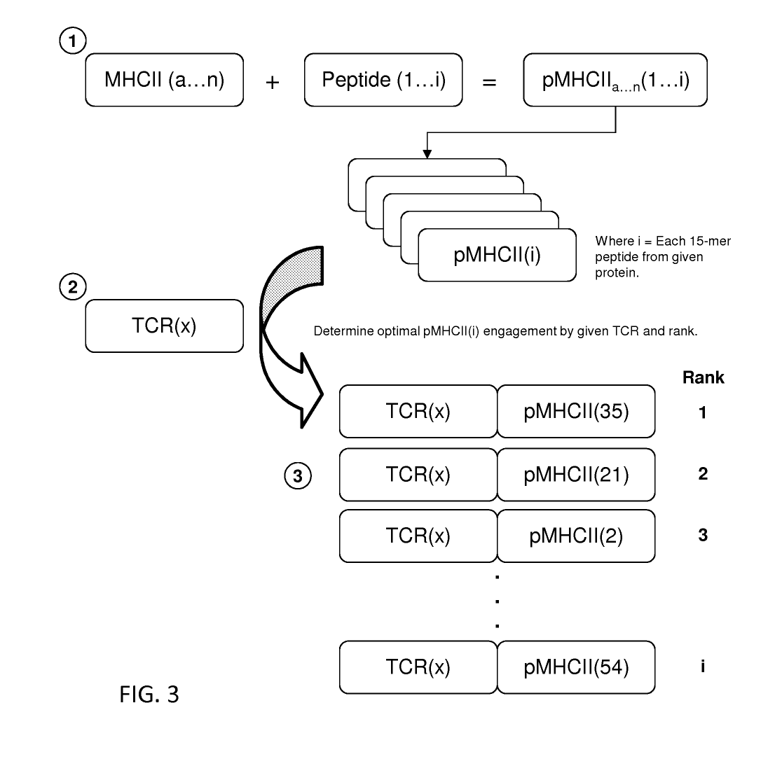

An embodiment of the above-described method is illustrated in FIG. 3. In this implementation, the method uses multiple MHCII models and multiple peptide models as inputs, where the peptide models represent every 15-mer peptide from a given protein. In some embodiments, the peptide models can be generated by moving a sliding window of defined size along the amino acid sequence of the protein to provide the different peptides. In this case, the window used was 15 amino acids in length (because that is similar to the size of a typical peptide that fits into the MHCII binding cleft). However, in practice, a window of a defined size in the range of 9 to 30 amino acids can be used. The embodiment illustrated in FIG. 3 is performed using a single TCR. In practice, the method can be done using models for many different TCRs, e.g., 2-1,000 TCRs. In particular embodiments, the method can be done using one or more immunodominant TCRs, which can be identified from the sequences of a T cell repertoire (which can be made in vitro or in vivo). In some embodiments, the TCR sequences can be obtained by stimulating T cell proliferation ex vivo, and sequencing the polynucleotides encoding the resultant T cell receptor repertoire.

In this method, n MHCII models are docked in a pairwise manner with i peptide structures (where i is the number of 15-mers from a given protein) to produce a plurality of peptide-MHCII combinations (pMHCIIa . . . n(1 . . . i)). As noted above, at this stage, pMHCII complexes can be eliminated if the peptide does not have a good fit into the binding groove of a MHCII protein. pMHCII can be eliminated using in silico methods, or using an in vitro method, for example. These complexes, in turn, are docked in a pairwise manner with a TCR protein, and scored according to the strength of the binding interactions, particularly the strength of the binding of the peptide in the MHCII complex to the TCR protein is calculated. The complexes are ranked (e.g., from weakest to strongest or vice versa, based on affinity, mean-field energy or any other suitable means) and a ranked list of TCR-pMHCII complexes is output.

The models employed in the method can be obtained from a variety of different sources. In some cases, the TCR and/or MHCII proteins can be modeled on known crystal structures of those molecules, several examples for which are known. Examples of methods for modeling the binding groove of MHCII proteins are known, e.g., De Rosa et al (PLoS One. 2010 5:e11550); Cardenas et al (J. Comput. Aided Mol. Des. 2010 24: 1035-51) and Menconi (Proc. Natl. Acad. Sci. 2008 105:14034-9), as are methods for modeling the CDR3 of a TCR protein (see, e.g., Leimgruber et al (PLoS One. 2011 6:e26301); Michielin et al (J. Mol. Bio. 2000 300:1205-35); Borg et al (Nature Immunology 2005 6:171-80); incorporated by reference). A peptide can be modeled based on available atomic coordinates, or its linear structure can be predicted by any of a variety of structure prediction programs that are known in the art.

Methods for docking a peptide to a MHCII protein to produce a pMHCII complex are known (e.g., Tong et al, Protein Sci. 2004 13: 2523-2532; Almagro et al, Protein Sci. 1995 4: 1708-1717; incorporated by reference). In some embodiments, peptide residues near the ends of the binding groove are docked by using an efficient pseudo-Brownian rigid body docking procedure followed by loop closure of the intervening backbone structure by satisfaction of spatial constraints, and subsequently, the refinement of the entire backbone and ligand interacting side chains and receptor side chains that have a poor fit at the MHC receptor-peptide interface.

### Utility

The above-described method has many applications. In a particular embodiment, the method can be employed to identify an immunostimulatory fragment of a target protein (e.g., a therapeutic protein). In these embodiments, the method can comprise identifying an immunostimulatory fragment of a protein, and altering that fragment, e.g., by altering the amino acid sequence of the fragment or by adding or removing a post-translational modification to or from the fragment, to decrease the immunogenicity of the protein. This method can be employed with any therapeutic protein, including but not limited to industrial, pharmaceutical, and agricultural proteins, including proteins that can be administered for the treatment of a blood disease or disorder, for example, anemia (e.g., aplastic anemia, fanconi anemia hemolytic anemia, sickle cell anemia hereditary spherocytosis, and thalassemia), hemoglobinuria, a blood coagulation disorder (including afibrinogenemia, factor V deficiency, factor VII deficiency, factor X deficiency, factor XI deficiency, factor XII deficiency, hemophilia A, hemophilia B, Von Willebrand disease, disseminated intravascular coagulation, antithrombin III deficiency, Bernard-Soulier syndrome, protein C deficiency, thrombasthenia, platelet storage pool deficiency, protein s deficiency), purpura (including evans syndrome and thrombotic thrombocytopenic purpura), blood group incompatibility, a blood platelet disorder (e.g., thrombocytopenia), a blood protein disorder (e.g., cryoglobulinemia and waldenstrom macroglobulinemia), myelodysplastic syndrome, a myeloproliferative disorder, hemoglobinopathy, or a leukocyte disorder (e.g., eosinophilia, kimura disease, leukopenia and neutropenia), etc.

The method can be employed with proteins which are targets for the treatment of cancer and other diseases etc. Examples of such target proteins include and are not limited to ligands, cell surface receptors, antigens, antibodies, cytokines, hormones, transcription factors, signaling modules, cytoskeletal proteins, toxins and enzymes. Non-limiting examples of therapeutic proteins include, adenosine deamidase, arginase, asparaginase, bone morphogenic protein-7, ciliary neurotrophic factor, DNase, erythropoietin, factor IX, factor VIII, follicle stimulating hormone, glucocerebrocidase, gonadotrophin-releasing hormone, granulocyte-colony stimulating factor, granulocyte-macrophage-colony stimulating factor, growth hormone, growth hormone releasing hormone, human chorionic gonadotrophin, insulin, interferon alpha, interferon beta, interferon gamma, interleukin-2, interleukin-3, interleukin-1, salmon calcitonin, staphylokinase, streptokinase, tissue plasminogen activator, and thrombopoietin. The parent protein can also comprise an extracellular domain of a receptor, including but not limited to CD4, interleukin-1 receptor, tumor necrosis factor receptors, and antibodies (including a murine, chimeric, humanized, camelized, llamalized, single chain, or fully human antibodies). Proteinaceous therapeutic agents can be naturally occurring or synthetic.

In another embodiment, the method can be employed to identify an immunologically inert fragment of a target protein. In these embodiments, the method can comprise identifying an immunologically inert fragment of a target protein, and altering that fragment e.g., by altering the amino acid sequence of the fragment or by adding or removing a post-translational modification to or from the fragment, to increase the immunogenicity of the protein. The protein can be from any infectious disease, e.g., anthrax, chickenpox, diphtheria, hepatitis A, B or C, HIB, HPV, seasonal influenza, encephalitis, malaria, measles, meningitis, mumps, pertussis, polio, rabies, rubella, shingles, smallpox, tetanus, TB or yeller fever, etc. New targets for cancer therapy can be identified using this methodology, e.g. by identifying immunogenic epitopes associated with cancer. These epitopes can then be used to design vaccines or enhance a pre-existing immune response against the particular epitope.

In some embodiments, the method can also be used to identify an auto-antigen in a subject having an autoimmune disease. In this embodiment, the T-cell repertoire of the individual can be sequenced, and protein sequences from the individual can be tested using the method described above to identify an immunodominant self-peptide, the sequence of which should allow the identification of the auto-antigen causing the autoimmune disease in the individual. In a similar embodiment, the method can be used to predict the immunogenicity of a plurality of fragments of a protein associated with a cancer, and to identify a fragment of the protein that is predicted to be immunostimulatory. The immunostimulatory fragment can be used as or developed into a cancer vaccine, for example.

In some of the above embodiments, it can be advantageous to do the modeling using structures for MHCII proteins that are prevalent in the population (such as North America, Asia, South America, North Africa, etc.) that is being targeted by a vaccine or therapeutic protein. In certain cases, the input MHCII proteins can correspond to the MHCII haplotype of an individual.

In any of the above embodiments, any change to the amino acid sequence of a protein can be tested using a variety of different assays such as a binding assay or a T cell proliferation assay. In some embodiments, an ex vivo T cell activation assays is used to experimentally quantitate immunogenicity (see for example Fleckenstein supra, Schmittel et. al., J. Immunol. Meth., 24:17-24 (2000), Anthony and Lehmann, Methods 29: 260-269 (2003), Stickler et al., J. Immunother. 23: 654-660 (2000), Hoffmeister et al., Methods 29: 270-281 (2003) and Schultes and Whiteside, J. Immunol. Meth. 279: 1-15 (2003), all entirely incorporated by reference). Any of a number of assay protocols can be used; these protocols differ regarding the mode of antigen presentation (MHC tetramers, intact APCs), the form of the antigen (peptide fragments or whole protein), the number of rounds of stimulation, and the method of detection (Elispot detection of cytokine production, flow cytometry, tritiated thymidine incorporation).

In some embodiments, the method can be employed to identify new targets for inflammation. In some embodiments, the T cell receptor repertoire of a subject having an inflammatory disorder can be sequenced, and an immunodominant T cell receptor identified. That receptor, complexed with the MHCII proteins from the subject, can be used to screen a number of peptide sequences (e.g., peptides representing the entire proteome of a subject) to identify the peptide that fits best with the receptor, thereby identifying the immunodominant epitope. Once the immunodominant epitope is known, it can be targeted for therapy.

Although the foregoing embodiments have been described in some detail by way of illustration and example for purposes of clarity of understanding, it is readily apparent to those of ordinary skill in the art in light of the above teachings that certain changes and modifications can be made thereto without departing from the spirit or scope of the appended claims.

### EXAMPLES

Aspects of the present teachings can be further understood in light of the following examples, which should not be construed as limiting the scope of the present teachings in any way.

### Example 1

Step 1: The amino acid sequence of the protein under study will be used to generate a series of overlapping 15 amino acid peptides using a Perl script (AA_process.pl). This method will be done by moving a window along the amino acid sequence of the protein under study to provide a series of peptides which will overlap with one another by 14 amino acid residues. The resulting output will be a text file with a list of overlapping 15-mer peptides comprising the entire length of the protein under study.

Step 2: Major histocompatibility complex class II (MHCII) proteins lacking x-ray crystallography structures will be modeled using MODELER (Discovery Studio, Accelrys) or an equivalent protein modeling software. This can be done through homology modeling of unknown structures using structures of resolved MHCII proteins. Structures that can be used for homology modeling can be found in the Protein Data Bank (PDB) website. Some examples of such structures are: 3QXA, 3L6F and 3PGD.

Step 3: Each peptide generated in Step 1 will also be modeled using MODELER or equivalent software.

Step 4: Peptides modeled in Step 3 will then be docked with MHCII structures modeled in Step 2, or with known MHCII structures from PDB, using a protein docking algorithm such as ZDOCK or RDOCK (Discovery Studio, Accelrys) to determine the most stable peptide-MHCII (pMHCII) combinations and confirmations. A multi-parametric scoring function will be used to rank the top pMHCII complexes based on affinity, confirmation and prevalence of each MHCII. A cut-off will be determined on a project-by-project basis.

Step 5: Sequences of T-cells responding to the protein under study will be determined via standard sequencing or next-generation sequencing techniques (e.g., AdaptiveTCR).

Step 6: Using sequences of known TCR from the PDB (e.g., 1TCR), homology modeling will be employed to predict each TCR structure based on the sequences obtained in step 5. Homology modeling can be performed using algorithms such as MODELER.

Step 7: Top pMHCII structures predicted in step 4 will be docked with TCR structures predicted in step 6 to determine the most conformationally stable pMHCII-TCR structures. ZDOCK, RDOCK or similar protein-protein docking algorithms will be used for this step. Top ranked structures will be based on affinity, confirmation and prevalence.

Step 8: The final output will be a ranked list of pMHCII-TCR models.

### Example 2

Given an MHCII sequence, a T cell receptor (TCR) sequence, and the sequence of a protein of interest, peptides derived from the protein of interest were ranked according to their predicted capacity to form a stable MHCII-peptide-TCR complex as follows.

The following two-step scoring protocol was developed to mimic the process of TCR-pMHC complex formation. First, the peptide sequence is modeled into the MHC cavity and the peptide-MHC interaction is refined and scored. Side-chain positions of both the peptide and the MHC are refined. This results in pMHC_score. Second, the TCR is added to the peptide-MHC complex from the previous step. The interface side-chains of both TCR and pMHC are refined, as well as TCR orientation with respect to pMHC. The score, TCR pMHC_score, is computed for the interaction between TCR and pMHC. Finally the final score is computed as the sum of the two scores:

Score=pMHC_score+TCR pMHC_score

In the current implementation, the FireDock scoring function was used (see Andrusier et al FireDock: fast interaction refinement in molecular docking. Proteins. 2007 69: 139-59 and Mashiach et al FireDock: a web server for fast interaction refinement in molecular docking. Nucleic Acids Res. 2008 36:W229-32). The FireDock function includes a weighted combination of softened van der Waals, desolvation, electrostatics, hydrogen bonding, disulfide bonding, π-stacking, aliphatic interactions, and rotamer preferences. This function may be replaced by a function that has statistical potential that shows better performance for protein-protein docking and loop modeling. Statistical potentials specifically for peptide-MHC-TCR interactions can be derived. MHC class I complexes can be used for training the potentials.

The FireDock method includes three main steps:

1. Side-chain optimization: The side-chain flexibility of the receptor and the ligand is modeled by a rotamer library. The optimal combination of rotamers for the interface residues is found by solving an integer LP problem. This LP minimizes a partial energy function consisting repulsive van der Waals and rotamer probabilities terms.

2. Rigid-body minimization: This minimization stage is performed by a MC technique that attempts to optimize an approximate binding energy by refining the orientation of the ligand structure. The binding energy consists of softened repulsive and attractive van der Waals terms. In each cycle of the MC method, a local minimization is performed by the quasi-Newton algorithm. By default, 50 MC cycles are performed.

3. Scoring and ranking: This final ranking stage attempts to identify the near-native refined solutions. The ranking is performed according to a binding energy function that includes a variety of energy terms: desolvation energy (atomic contact energy, ACE), van der Waals interactions, partial electrostatics, hydrogen and disulfide bonds, π-stacking and aliphatic interactions, rotamer's; probabilities and more.

### Example 3

The ternary MHCII-peptide-TCR complex can be modeled using available crystal structures as templates for new complexes. The PDB currently contains nine human MHCII-peptide-TCR complexes (NCBI structure accession numbers 1j8h, 1fyt, 4e41, 2iam, 2ian, 1ymm, 3p16, 3o6f, and 1zgl) that can serve as templates. In addition, there is a similar number of structures of human MHCII-peptide-TCR complexes that can serve as templates.

The second part of this study combines the three-component complex modeling with the scoring function, followed by refinement of the algorithm. The scoring protocol and the modeling protocol were combined and tested using available structures for the complexes. A full length sequence for each of the peptides in the complexes was been identified, and all of the peptides in those full length sequence were modeled using the modeling algorithm described above. The scores were computed using the methods described above. The rank of the correct peptide was determined and compared to results obtained from the NetMHCII predictor (Nielsen et al BMC Bioinformatics. 2007 8:238). These results are shown in Table 1 below.

As shown in the table below, the structure-based method ranks a number of the test peptides higher than the NetMHCII method. As such, based on the results shown in Table 1 below, the structure-based method described above is better at predicting the actual result than the traditionally used sequence based prediction method (NetMHCII).

TABLE 1
Benchmark of peptide specificity using crystal structures.

| | | | | | | | | | Rank |
|---|---|---|---|---|---|---|---|---|---|
| | | | | | | | Rank | Rank | NetMHCII |
| PDB | Protein | Peptide | length | MHCII | TCR | Rank | MHC | TCR | (core) |
| 1j8h | HEMAGGLUTININ HA1 | PKYVKQNTLKLAT (SEQ ID | 13 | DRB1*0401 | TCR HA1.7 | 2 | 3 | 9 | 25 |
| | | NO: 1) | | | | | | | |
| 1fyt | HEMAGGLUTININ HA1 | PKYVKQNTLKLAT (SEQ ID | 13 | DRB1*0101 | TCR HA1.7 | 6 | 16 | 19 | 20 |
| | | NO: 2) | | | | | | | |
| 4e41 | TRIOSEPHOSPHATE | GELIGILNAAKVPAD (SEQ | 15 | DRB1*0101 | TCR G4 | 1 | 1 | 13 | 1 |
| | ISOMERASE | ID NO: 3) | | | | | | | |
| 2iam | TRIOSEPHOSPHATE | GELIGILNAAKVPAD (SEQ | 15 | DRB1*0101 | TCR E8 | 3 | 2 | 159 | 1 |
| | ISOMERASE | ID NO: 4) | | | | | | | |
| 2ian | TRIOSEPHOSPHATE | GELIGTLNAAKVPAD (SEQ | 15 | DRB1*0101 | TCR E8 | 1 | 1 | 63 | 1 |
| | ISOMERASE | ID NO: 5) | | | | | | | |
| 1ymm | MYELIN BASIC PROTEIN | ENPVVHFFKNIVTP (SEQ | 14 | DRB1*1501 | TCR | 1 | 1 | 17 | 1 |
| | | ID NO: 6) | | | OB.1A12 | | | | |
| 3pl6 | MYELIN BASIC PROTEIN | NPVVHFFKNIVTPR (SEQ | 14 | DQB1*0501 | | 1 | 1 | 10 | 3 (1) |
| | | ID NO: 7) | | | | | | | |
| 3o6f | MYELIN BASIC PROTEIN | FSWGAEGQRPGFGSGG | 16 | DRB1*0401 | | 15 | 38 | 12 | 139 |
| | | (SEQ ID NO: 8) | | | | | | | |
| 1zgl | MYELIN BASIC PROTEIN | VHFFKNIVTPRTPP (SEQ | 14 | DRB5*0101 | | 5 | 3 | 25 | 9 (7) |
| | | ID NO: 9) | | | | | | | |

1. A computer system comprising a memory comprising:
a) a model of a peptide, a model of a MHCII protein and a model of a T cell receptor; and
b) an executable program for:
(i) evaluating the strength of intermolecular interactions of a complex comprising the peptide, the MHCII protein and the T cell receptor to provide a score that predicts the immunogenicity of the peptide; and
(ii) outputting the score.

2. The computer system of claim 1, further comprising instructions for displaying an image of the complex.

3. The computer system of claim 1, wherein the memory comprises models for a plurality of different peptides, a model of the MHCII protein and a model of the T cell receptor; and the memory comprises executable programming for:
evaluating the strength of intermolecular interactions of complexes containing the different peptides to provide scores that predict the immunogenicity of the peptides;
ranking the different peptides by their scores; and
outputting a list of the different peptides ranked by their scores, wherein said outputting provides a ranked immunological profile for the peptides.

4. A computer readable storage medium comprising an immunogenicity prediction program comprising instructions for:
a) evaluating the strength of intermolecular interactions of a complex comprising a peptide, a MHCII protein and a T cell receptor to provide a score that predicts the immunogenicity of the peptide; and
b) outputting the score.

5. The computer readable storage medium of claim 4, wherein the evaluating is done by three dimensionally modeling the complex.

6. The computer readable storage medium of claim 4, wherein the immunogenicity prediction program comprises instructions for:
a) evaluating the strength of intermolecular interactions of a plurality of complexes each comprising a peptide, a MHCII protein and a T cell receptor, wherein the complexes comprise different peptides and the evaluating produces a score for each of the complexes;
b) ranking the different peptides by their scores; and
c) outputting a list of the different peptides ranked by their scores, thereby providing an immunological profile for the peptides.

7. The computer readable storage medium of claim 6, wherein the program further comprises instructions for inputting a protein sequence and instructions for moving a sliding window of defined size along the amino acid sequence of a protein to provide the different peptides.

8. The computer readable storage medium of claim 7, wherein the defined size ranges from 9 to 30 amino acids.

9. The computer readable storage medium of claim 6, wherein program further comprises instructions to identify peptides that are immunostimulatory.

10. The computer readable storage medium of claim 6, wherein the complexes further differ from each other by one or more of the amino acid sequence of the MHCII protein and the amino acid sequence of the T cell receptor.

11. The computer readable storage medium of claim 6, wherein the complexes comprise different T cell receptors, where the different T cell receptors represent at least a portion of the T cell receptor repertoire of an individual.

12. A method of predicting the immunogenicity of a peptide, comprising:
a) inputting sequence information of the peptide into a computer system comprising an immunogenicity prediction program comprising instructions for:
(i) evaluating the strength of intermolecular interactions of a complex comprising the peptide, a MHCII protein and a T cell receptor, to provide a score that predicts the immunogenicity of the peptide; and
(ii) outputting the score;
b) executing the immunogenicity prediction program; and
c) receiving the score from the computer system.

13. The method of claim 12, wherein the method comprises inputting sequence information for two or more different peptides into the computer system; and receiving a list of the different peptides that are ranked by their scores.

14. The method of claim 13, wherein the two or more different peptides represent different fragments of the same protein.

15. The method of claim 14, further comprising reviewing the list of different peptides to identify an immunostimulatory fragment of the protein.

16. The method of claim 15, further comprising altering the amino acid sequence of the immunostimulatory fragment to decrease the immunogenicity of the protein when it is administered to a mammal.

17. The method of claim 15, further comprising altering a post-translational modification of the immunostimulatory fragment to decrease the immunogenicity of the protein when it is administered to a mammal.

18. The method of claim 14, further comprising reviewing the list of different peptides to identify an immunologically inert fragment of the protein.

19. The method of claim 18, further comprising altering the immunologically inert fragment to increase the immunogenicity of the protein when it is administered to a mammal.

20. The method of claim 12, wherein the evaluating comprises evaluating the strength of interactions between: a) the T cell receptor and b) the peptide in a complex comprising the peptide and the MHCII protein.

21. The method of claim 12, wherein the evaluating further comprises evaluating the strength of interactions between: a) the peptide and b) the MHCII protein.

22. The method of claim 12, wherein the evaluating comprises evaluating the strength of interactions between: a) a peptide and b) the peptide binding cavity of a complex comprising a MHCII protein and a T cell receptor.

23. The method of claim 12, wherein the method further comprises inputting sequence information of the MHCII protein and/or the T cell receptor into the system.

24. The method of claim 12, wherein said method is a peptide from a vaccine, and the method further comprises altering the peptide to increase the immunogenicity of the vaccine.

25. The method of claim 12, wherein the method is used to predict the immunogenicity of a plurality of fragments of a protein associated with a cancer, and identifying a fragment of said protein that is predicted to be immunostimulatory.


SEQUENCE LISTING (9 sequences)

SEQ ID NO: 1 - protein, 13 aa, homo sapien
PKYVKQNTLKLAT

SEQ ID NO: 2 - protein, 13 aa, homo sapien
PKYVKQNTLKLAT

SEQ ID NO: 3 - protein, 15 aa, homo sapien
GELIGILNAAKVPAD

SEQ ID NO: 4 - protein, 15 aa, homo sapien
GELIGILNAAKVPAD

SEQ ID NO: 5 - protein, 15 aa, homo sapien
GELIGTLNAAKVPAD

SEQ ID NO: 6 - protein, 14 aa, homo sapien
ENPVVHFFKNIVTP

SEQ ID NO: 7 - protein, 14 aa, homo sapien
NPVVHFFKNIVTPR

SEQ ID NO: 8 - protein, 16 aa, homo sapien
FSWGAEGQRPGFGSGG

SEQ ID NO: 9 - protein, 14 aa, homo sapien
VHFFKNIVTPRTPP